(19) United States
(12) Patent Application Publication
(10) Pub. No.: US 2008/0237334 A1
(43) Pub. Date: Oct. 2, 2008

(54) Goods Delivery System, Method for Delivering Goods, Distribution Components and Dispatching Point for Goods

(75) Inventor: Keith Ulrich, Bonn-Oberkassel (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/088,911

(22) PCT Filed: Sep. 22, 2006
(86) PCT No.: PCT/EP06/09241

§ 371 Date: Apr. 1, 2008

(30) Foreign Application Priority Data
Oct. 7, 2005 (EP) 05021967.4

(51) Int. Cl. G06F 17/00

(52) U.S. Cl. 235/375

(57) ABSTRACT

A system for sending an information carrier to a recipient is disclosed. An exemplary system comprises an editing component that enables editing mailing address data of the recipient in order to create a printing job and an interface to transmit the mailing address data to a printing component that is adapted to print at least information about one or more dispatch points onto a mailing and/or onto a communication that can be enclosed with the mailing. The exemplary system also comprises a database containing information about goods to be delivered and about at least one dispatch point intended for the delivery of the goods, a linking element that is adapted to link information about the goods to be delivered to the mailing address data of the recipient and an interface to transmit information about the dispatch points to the printing component. The exemplary system further comprises a writing component with which information about goods to be delivered is written onto an information carrier in machine-readable form. Further, the exemplary system comprises a goods delivery system including a logistics system in which information pertaining to the goods to be delivered is sent with the information carrier, wherein the information carrier is sent to a different mailing address than the goods that are to be delivered by the goods delivery system, and wherein the goods delivery system comprises at least one dispatch point at which the goods to be delivered are present, and wherein the dispatch point contains a signal emitter for the association of the goods to be delivered on the basis of the machine-readable information.

### CROSS REFERENCE TO RELATED APPLICATIONS

Pursuant to 35 U.S.C. §371, this application is the United States National Stage Application of International Patent Application No. PCT/EP2006/009241, filed on Sep. 22, 2006, the contents of which are incorporated by reference as if set forth in their entirety herein, which claims priority to European Patent Application No. 05021967.4, filed Oct. 7, 2005, the contents of which are incorporated by reference as if set forth in their entirety herein.

The invention relates to a goods delivery system, to a method for delivering goods, to a sending component and to a dispatch point for goods.

A known problem encountered with methods for delivering goods is the difficulty in reaching the intended recipient.

Electronic parcel deposit box facilities are known, which solve the problem of delivering shipments of goods to people who cannot be reached at their mailing addresses. Such electronic parcel deposit box facilities are disclosed in the following European patents of the Deutsche Post AG: EP 1 408 801 B1; EP 1 408 802 B1; EP 1 409 160 B1 and EP 1 421 537 B1.

Moreover, systems and methods are known for placing orders via electronic message networks. An acknowledgement of the prior-art ordering systems and methods as well as an especially preferred embodiment thereof can be found in European patent EP 927 945 B1.

German patent DE 103 24 538 of the Deutsche Post AG describes a non-generic method for automatically placing orders and performing printing services as well as postal services within a sending service system.

Another non-generic method is known from European patent EP 1 279 132 B1 of the Deutsche Post AG. In this known method, monetary-value information is downloaded from a charging point, whereby a random number and a payment identification number are generated in the charging point, whereby a seller receives the character string as a monetary-value amount for a payment and whereby the seller also submits the character string to an eCommerce Center in order to verify the validity and to effectuate a payment.

Likewise known is the use of transponders in numerous technological realms. Transponders are receiving devices that emit their own signal after the receiving.

The word “transponder” is short for transmitter-responder.

Moreover, it is also a known procedure to employ RFID technologies involving transponders that can be written on and read out multiple times in order to replace or augment the visually detectable labeling of objects in transport or logistics systems. Such systems have the advantage that a large amount of information can be electronically read in and out of a transponder, as a result of which automatic transporting, sorting, tracking or distributing procedures can all be controlled without the need for the visual display of information.

An example of the use of RFID transponders in the postal realm is disclosed in international patent application WO 03/098533 A1. The RFID transponders are attached to mailings which are then sorted on the basis of the information that can be read in and out, after which they are transported to a delivery location.

Another use of RFID labels is disclosed in German utility model DE 202 07 972 U1, which describes load carriers such as pallets with transponders. Here, information such as the owner, the contents or the load carrier identification number of a labeled load carrier are stored in the transponder.

A transponder with identification information (an RFID transponder) is normally configured as an RFID tag. An RFID tag consists of a microchip and an antenna. A code is stored on the chip and this code contains processing-relevant information. In particular, this is information about the identification ID data.

Transponders are configured in such a way that they themselves transmit and/or receive signals in response to a triggering (radio) signal of a reading device. Active transponders contain an energy supply for their operation. In contrast, passive transponders receive energy from the signals emitted by the reading device.

### SUMMARY OF THE INVENTION

An exemplary embodiment of the present invention is based on the objective of creating a goods delivery system that allows the delivery of the goods to be highly flexible.

An exemplary embodiment of the present invention comprises an innovative logistics system that automates and greatly simplifies the handing over of goods to the intended recipients.

In this context, the term “logistics system” relates to any system that is suitable for handing over goods to the intended recipients.

The goods delivery system according to the invention is a logistics system in which information pertaining to the goods to be delivered is sent with an information carrier, whereby the information carrier is preferably sent to a different (mailing) address than the goods that are to be delivered by the goods delivery system.

In order to increase the availability of the goods, several dispatch points are advantageously provided where the goods to be delivered are located.

The technical implementation of the invention preferably comprises a database containing information about the goods to be delivered and about at least one dispatch point intended for the delivery of the goods.

It is especially advantageous for the database to contain information about several dispatch points intended for the delivery of the goods.

A preferred embodiment of the invention provides that the information carrier that initiates the handing over of the goods is sent to a mailing address of an intended recipient of the goods and that the goods are made available for pick-up at a dispatch point that differs from the mailing address of the recipient.

Here, it is especially advantageous to provide several dispatch points that each make one or more items of essentially the same kind of goods available for pick-up.

In this manner, the dispatching of the goods can be rendered more flexible.

In order to increase the flexibility, it is also advantageous if the information that is stored in the information carrier about the goods to be delivered is configured as identifier information.

The association of the goods with the identifier information can be carried out flexibly, for example, as a function of a definable period of time, for example, monthly, during a season or for the duration of a special campaign.

The association of the goods with the information stored in the information carrier can thus be configured flexibly by using the identifier information.

In order to ensure this flexibility, it is advantageous for at least one of the dispatch points, preferably several of the dispatch points, especially essentially all of the dispatch points, to be configured in such a way that they can be operated with association information, whereby the association information of the identifier information is to be associated flexibly with at least one or more pre-definable criteria of appertaining goods.

The use of at least one database is advantageous in order to make such associations possible and also in order to be able to carry out the other described processing procedures.

The database can be implemented in several different ways.

For example, it is possible to create categories of dispatch points and to provide that each of these dispatch points contains at least one item of the goods to be delivered.

Such an embodiment is especially advantageous if large quantities of the goods to be delivered are going to be distributed via the system.

Preferred quantities range from several hundred essentially or completely identical goods to several hundred thousand goods that are to be distributed.

In another practical embodiment of the invention, the database is connected to a goods management system or, even more advantageously, it is integrated into the goods management system. The connection to the goods management system or the integration into the goods management system—even in case of small quantities of goods to be delivered—increases the availability of the goods to be delivered at the dispatch points.

Such goods management systems are known from the state of the art.

An especially preferred goods management system controls goods-oriented disposition-related, logistical or accounting-relevant processes for the execution of the deliveries of the goods.

A goods management system is especially a system having one, several or all of the following components:
selling with price quote, ordering, delivery packing slip, invoice. Also augmented by order confirmation, workshop order, warehouse issuing document, cancellation invoicing, customer tracking for the management of information for customer care (Customer Relationship Management, CRM);
warehousing with inventory management, minimum inventory. The internal inventory management is carried out in the goods management system on the basis of the data about sales and purchases (incoming goods from suppliers);
purchasing with order proposal determination, ordering. A goods management system can determine order proposals and can trigger the placement of an order based on the sales data (ordered goods, sold goods) and on the warehousing data.

Moreover, it is advantageous for the goods management system to comprise one or more of the following components:
management of sales branches;
data exchange via standardized interfaces (e.g. Datanorm, Datev, eBay, Online-Shop);
statistical evaluations of the data from the goods management system;
interface to a production planning and control system (PPS).

The information processed or stored in the goods management system can be taken into account when the mailings are generated. It is especially advantageous to incorporate the dispatch points that are recorded in the goods management system via an interface to transmit information about the dispatch points to a printing component.

It is also advantageous if information about one or more items to be picked up from the goods management system is transmitted to the information carriers that are to be integrated into the mailing or that can be attached to the mailing.

Moreover, it is advantageous for the mailings that serve for sending the information carriers to be generated in the most automated manner possible.

An especially preferred system for the automated generation of the mailings is offered by the Deutsche Post AG under the designation “Mailingfactory”.

Processing steps that are presented in another technical context in German patent DE 103 24 538 (integration of pictures taken by a mobile device into the mailings) are especially well-suited for generating the mailings.

A modification of this known system for the new technical effect being presented here is especially advantageously achieved by a linking element that is configured in such a way that it links information about the goods to be delivered to the mailing address data of the recipient.

In order to further improve the automated generation of the mailings, it is advantageous for the goods delivery system or the sending component to have an editing component to edit the address data of the recipient in order to create a printing job.

It is also practical to provide an interface to transmit the mailing address data to a printing component.

Preferably, the printing component is configured in such a way that it can print either onto the mailing or else onto the address carrier that can be attached to the mailing.

In an advantageous manner, the mailing is printed on using known printing methods. The printing of mailing address data onto the mailing is particularly advantageous if the mailing already contains additional desired contents, especially the information carrier with the information about at least one item that is to be delivered.

However, it is likewise possible to first print onto the mailing and to subsequently incorporate the information carrier.

It is also possible to print the mailing address data onto a communication that is to be enclosed with the mailing so that, in a known manner, this communication can be read in an address reading field of the mailing.

It is also practical to provide an interface to transmit information about the dispatch points to the printing component or to an additional printing component.

Advantageously, the printing component or the additional printing component is configured in such a way that it can print information about one or more dispatch points onto a mailing and/or onto the communication that can be enclosed with the mailing.

An especially preferred embodiment of the invention provides that the information about the goods to be delivered is written onto an information carrier in machine-readable form by means of a writing component.

In this context, the writing component can have different properties and be configured, for instance, as a printing unit or as an electromagnetic transmitting unit.

An especially preferred embodiment of an electromagnetic transmitting unit—a transmitting unit in the radio frequency range (within the kHz range all the way to the GHz or THz ranges) makes it possible to write onto transponders electromagnetically.

The information can be configured in such a way that it can be read and evaluated by any desired electromagnetic reading unit that operates within the same frequency range.

In order to prevent the fraudulent generation of information, it is advantageous to encrypt the information.

In this context, it is fundamentally advantageous if the machine-readable information about the goods to be handed over is generated and processed according to the modality of PayMarks presented in this application.

By the same token, however, other methods for generating and processing the encrypted information are also practical.

For example, methods known for generating digital information for postage indicia are also suitable to generate, process and optionally evaluate the information contained in the information carrier.

Regarding advantageous embodiments of the digital postage indicia, reference is hereby made to the entire following document: S36-3 Draft H Digital Postage Marks (DPM)—Applications, security & design; Universal Postal Union—International Bureau, Standards Programme 3000, Bern 15, Switzerland, the contents of which is hereby incorporated by reference as though fully set forth herein.

An especially preferred embodiment of the inventive goods delivery system, of the inventive method to deliver goods as well as of the inventive sending component is characterized by a writing component that is configured in such a way that it can print a two-dimensional or three-dimensional code as machine-readable information and by the fact that a printed object serves as the information carrier for the information about the goods to be delivered.

The design of the printed object as graphically recognizable information about the goods to be delivered is especially advantageous.

This makes it possible for the recipient of the mailing to obtain direct information about the item or goods to be delivered.

The information can be contained either in very concrete form or in generalized form.

Very concrete information is particularly well-suited if the invention is integrated into electronic ordering systems in which the recipient conceivably wishes to be provided with the most detailed information possible about the goods to be delivered.

Another preferred embodiment of the invention, however, provides that the information about the goods to be delivered is expressed in the most generalized form possible.

This translates into a surprise effect for the recipient of the sent goods. This is particularly advantageous if the invention is used as a rewards system and/or to reward the recipients.

In this case, the recipient receives, for example, the information that goods to be delivered are ready for him in one or more business establishments and/or at one or more dispatch points.

The graphically recognizable information about the goods to be delivered can be configured in a wide variety of ways. For example, a graphic reproduction of the goods or else a symbol that represents the goods can be placed on the mailing itself. Graphic images on a label or on a communication that is to be enclosed with the mailing are also advantageous.

The graphic information can be designed in various ways.

However, it is particularly advantageous for the printing component or for the additional printing component that serves to print the graphic information to likewise function as a writing component with which the information about the goods to be delivered is written onto the information carrier in machine-readable form.

Another preferred embodiment of the invention is characterized in that the writing component contains a transmitter for electromagnetic radiation and in that a transponder that is attached to or can be attached to the mailing serves as an information carrier for the information about the goods to be delivered.

The mailing provided with the information carrier is transported to the recipient via the usual postal route.

The transportation of the goods to the dispatch point takes place in another transportation procedure.

It is also practical if the data-processing procedures for the transportation of the mailing are separated from the data-processing procedures for the goods since this considerably reduces the data-processing resources needed. Such a separation, however, is not a prerequisite.

In an especially preferred embodiment of the invention, the goods are transported to the dispatch point separately from the conveyance of the mailings to the intended recipients of the sent goods.

It is also practical for the transportation procedure of the information carrier to the intended recipient of the goods and for the transportation of the goods to take place via separate transportation processes and preferably also using shipping logistics that are uncoupled from each other.

This makes it possible to reduce the data-processing resources needed.

According to the invention, information about the pick-up points where at least one item of the goods is ready to be picked up can be stored in the information carriers.

This is particularly advantageous if the invention is meant to be used to distribute multiple similar or identical goods—especially serially produced items—to multiple recipients.

For instance, this allows serially produced items to be handed over to final consumers.

This embodiment as well as the other embodiments of the invention allow a choice to be made in terms of payment either by the recipient—preferably initiated at the time of the placement of the order for the goods—or by other persons—for example, a seller in an Internet auction or else when the item is a gift to the recipient.

An especially advantageous embodiment of the invention is characterized in that the recipient is notified in the case of at least one sending event.

The term “sending event” describes an event associated with one of the process steps involved in the generation, processing and/or receipt of the mailing.

In a practical manner, it is checked here whether one or more pre-definable conditions for the generation, conveyance or delivery state of the mailing have been fulfilled. A notification is automatically generated as the result of the evaluation of this at least one condition.

One especially preferred sending event is the storage of the information onto the information carrier.

Here, the recipient can receive the electronic notification either prior to the storage of the information onto the information carrier, during the storage of the information onto the information carrier or subsequent to the storage of the information onto the information carrier.

Suitable means for the electronic notification are all types of digitally transmitted information, for instance, an e-mail, an SMS, an MMS, a Telnet message or another type of electronically transmittable information.

The notifications presented here can be made in the case of one or several sending events.

In a particularly advantageous embodiment, it is checked whether the mailing has been dropped off in a mail-processing system and the recipient is notified when the drop-off of the mailing there is recorded.

It is also advantageous for an identification of the mailing and/or the information carrier contained in it to be carried out during the processing of the mailing in a mail-processing machine.

In a practical manner, the notification of the recipient of the mailing is carried out on the basis of the identification of the mailing and/or of the information carrier contained in it.

Examples of mail-processing machines that can be used in a particularly advantageous manner are positioning machines and/or sorting installations.

The integration of the recording step into the processing procedure of the mailings has the advantage that a plurality of mailings and/or the information carriers contained in them can be ascertained with little processing effort, thereby allowing the integration of the notification into a mass processing of mailings.

In particular, this also means that this advantageous refinement of the invention can be easily integrated into mail and package centers.

Another sending event that can be evaluated for the generation of the notifications is the placement of the mailing into a mailbox of the recipient.

The presented processing procedures for the mailings can take place selectively either in combination with the delivery of the goods to the dispatch points or else uncoupled from this, depending on the desired execution conditions in each case.

According to the invention, at least one dispatch point for goods is provided.

It is especially practical for the system to comprise multiple dispatch points.

It is particularly advantageous for the dispatch points to contain, at least in part, the same or identical goods.

In a practical manner, the dispatch points are configured in such a way that they each have at least one signal emitter that is connected to a reading unit for reading the information stored in the information carrier.

For the eventuality that the information carrier contains the information about the item or goods to be delivered in graphic form—for instance, in the form of a one-dimensional or two-dimensional barcode—it is practical for the reading unit to have a CCD element, for example, a CCD sensor or a CCD camera.

A charge-coupled device (CCD) is a light-sensitive electronic component to measure the light intensity with spatial resolution. CCDs are usually made up of semiconductors.

The component preferably consists of a matrix or a line with light-sensitive cells, which are called pixels (picture elements). The charge that is proportional to the light quantity is coupled out of each cell and then stored for further processing

In the case of a video camera, a distinction is made between frame transfer (FT), interline transfer (IT) and frame interline transfer (FIT) methods. These out-couple the charges from the light-sensitive cells to the storage cells in a different manner. In particular, they differ in terms of the coupling time.

The CCD chip of a digital camera consists of a matrix (array) of 100,000 to several tens of millions of light-sensitive cells corresponding to the pixels of the acquired image. Their shape is rectangular or square, with an edge length that is normally several micrometers. Fine electric lines runs between them and even though these lines entail light losses, they serve to read out and to shield overexposed cells. Consequently, larger pixels mean higher light sensitivity but lower resolution and thus less sharp images. This process, however, only yields grayscale images.

CCD lines, so-called “stripes”, are also suitable instead of light-sensitive surfaces.

The use of these detectors called stripes is particularly well-suited for the application case where a one-dimensional code is read out or where a relative movement occurs between the sensor and the graphically reproduced information.

However, it is especially advantageous to use sensors in the form of an array since then the optical information can be directly acquired in a single process step.

Numerous reading devices are an option when transponders are employed as the information carriers.

Antennas that are each tuned to the wavelength of the electromagnetic radiation of the transponders are used.

The possibility of reading out several transponders in rapid succession makes corresponding requirements of the reading unit to be employed in each case.

It is especially advantageous to configure the reading unit with a BRM function known from the state of the art.

The BRM function (buffered reading mode=data filtering and data storage) ensures that the data of transponders that have already been read out goes into buffer storage in the reader and are only read out once. This advantage comes to the fore in applications with batch recognition (anti-collision) since only “new” transponders are read out every time. This increases the data transmission speed.

The information acquired in this manner is subsequently further processed.

If the information has been encrypted, it is practical to at least partially decrypt it so that it can be incorporated into the subsequent processing steps.

A signal emitter is controlled on the basis of the information contained in the information carrier.

The signal emitter is configured in such a manner that it brings about an association of the goods to be delivered on the basis of the machine-readable information.

The signal emitter can be configured in various ways.

In a first simple embodiment, the signal emitter controls an optical display. The optical display can comprise, for instance, information about the goods and/or an image of the goods.

However, it is likewise possible for the signal emitter to control the opening of a compartment, for example, of an electronic parcel deposit box facility.

It is also possible for the signal emitter to control the feeding of the goods into a goods-dispensing chute.

The goods can be fed into the goods-dispensing chute using, for example, a conveyor belt and/or a gripper arm.

It is also practical to connect the signal emitter to a material-flow control computer of a warehouse located in the area of the pick-up point.

The warehouse can be fundamentally configured in a known manner, for example, as a high-bay rack system or as a cyclic elevator warehouse.

### BRIEF DESCRIPTION OF THE DRAWINGS

FIG. 1 is a block diagram of a sending component according to an exemplary embodiment of the present invention connected to an order component according to an exemplary embodiment of the present invention;

FIG. 2 is a block diagram of a system according to an exemplary embodiment of the present invention;

FIG. 3 is a schematic depiction of a postcard generated with a method and system according to an exemplary embodiment of the present invention, in a version printed on both sides;

FIG. 4 is a schematic depiction of a dispatch point according to an exemplary embodiment of the present invention.

### DETAILED DESCRIPTION OF SPECIFIC EMBODIMENTS

In accordance with an exemplary embodiment of the present invention, the inventive goods delivery system, the inventive method for delivering goods and the inventive sending component are preferably connected to a suitable order component.

Advantageously, the goods delivery system comprises a linking element, whereby said linking element is configured in such a way that it links information about the goods to be delivered with address data of the recipient.

In an especially preferred embodiment of the invention, this linking is done through interaction with a computer-based ordering system.

The computer system can be configured in various ways. For instance, it is possible to provide a material-flow control computer that links information about goods on hand with information about destinations.

Electronic ordering systems using computer networks, particularly the Internet, are especially preferred, without this being construed as a restriction of the general applicability of the goods delivering system according to the invention.

Ordering procedures in the computer network are advantageously carried out using a data-transmission protocol suitable for this purpose. Especially preferred examples of these are e-mails and the World Wide Web (“WWW”). The WWW services especially involve communication between a client and a web server. In order to acquire information, requests are made according to a suitable protocol, especially the HyperText Transfer Protocol (HTTP). The website is preferably displayed using a browser.

Data contents are preferably processed using HyperText Markup Language (HTML).

Especially preferred is the use of the Extensible Markup Language. Extensible Markup Language, abbreviated XML, is a standard for the generation of machine-readable and human-readable documents in the form of a tree structure. Here, XML defines the rules for the structure of such documents. For a concrete application case (“XML application”), the details of the documents in question have to be specified. In particular, this pertains to the specification of the structural elements and to their arrangement within the document tree. Therefore, XML is a standard for defining any desired markup languages whose basic structures, however, are closely related.

The names of the individual structural elements (XML elements) for a concrete XML application can be selected at will. An XML element can contain or describe completely different data, the most prominent example of this being text, but also graphics or abstract knowledge. A basic notion behind XML is to separate data and its representation.

Preferably using structured ordering elements, buyer-specific ordering information—which is preferably associated with a client system—is combined with the ordering information for the goods to be delivered. Furthermore, a link is created to at least one piece of mailing address data pertaining to the intended recipients of the goods.

In contrast to the known ordering systems, however, the goods to be delivered are not sent to the recorded mailing address of the recipient. Instead, in an especially preferred embodiment of the invention, the only thing that is transported to the mailing address of the customer is an information carrier containing information in machine-readable form, while the goods are made available at a different place.

The method is characterized by various steps, the start of which is the generation of order data by means of a terminal device, whereby the order data consists of at least one piece of ordering information and at least one piece of delivery information.

The order data is transmitted to a processing component of the goods delivery system. Subsequently, the order data is transferred to a verification and processing component. The order data is verified in the verification and processing component, processed and then transmitted to an interface of the sending service system. Prior to that, the order data is stored in a database. In particular, erroneous data or data with which errors occurred during the transfer to the interface is appropriately stored in the database. From the interface, the data is transferred to a second database, said database belonging to the sending service system. The database is connected to an editing component that edits the order data in order to create a writing job in which the information about the goods to be delivered is written onto a data carrier in machine-readable form. Subsequently, the writing job is transmitted to a writing component for purposes of writing the information about the goods to be delivered and a mailing is generated and the information carrier in integrated. The generated mailing is transferred to a distribution system.

The transmission of monetary-value information for goods to be delivered and/or the sending service performance—postal sending of the mailing—are invoiced by means of an invoicing component of the sending service system.

The invoicing for the services rendered can be carried out in various ways.

However, it is especially advantageous to integrate an invoicing component that allows a fast and reliable invoicing for the services rendered.

In particular, the use of electronic payment systems is very practical.

Especially advantageous are invoicing components that process monetary-value information.

In a practical manner, the monetary-value information of a party placing the order for the services—especially the transportation service and the handing over of the goods—is loaded from a charging point and used to pay for these services.

In this context, the charging point serves as a value-transfer center.

An especially preferred embodiment of the invention provides for the invoicing to take place in accordance with the method disclosed in European patent specification EP 1 279 132 B1, the contents of which are hereby incorporated by reference as though fully set forth herein.

For this purpose, the party placing the order for the provided services downloads monetary-value information in the charging point. In a practical manner, an authentication of the party placing the order is carried out for this purpose.

Once the authentication of the party placing the order has been carried out, a random number and a payment identification number (Pay-ID PID) containing information about the ordering party are formed in the charging point.

Subsequently, the random number and the Pay-ID PID are encrypted in the manner described in European patent specification EP 1 279 132 B1, the contents of which are hereby incorporated by reference as though fully set forth herein.

Subsequently, the above-mentioned information is stored in a crypto-module, advantageously in encrypted form.

Moreover, information about the goods to be delivered—advantageously at least their price—is entered into the crypto-module.

Then the crypto-module uses the provided data to generate a hash value.

The crypto-module (also referred to as a cryptographic module) is preferably configured in such a way that data can be processed in it in an unsecured manner.

The cryptographic module is characterized in that its interior contains electronic data or processes data that cannot be seen or manipulated from the outside without this being noticed.

A cryptographic module can be regarded as a safe, sealed unit in which security-relevant processes are carried out that cannot be manipulated from the outside. A worldwide recognized standard for such cryptographic modules is the standard for cryptographic modules published by the U.S. National Institute of Standards and Technology (NIST) bearing the designation FIPS Pub 140, published as “FIPS PUB 140-1 (supersedes FIPS PUB 140 Apr. 14, 1982), Federal Information Processing Standards Publication 140-1, Jan. 11, 1994 SECURITY REQUIREMENTS FOR CRYPTO-GRAPHIC MODULES”, published by the National Institute of Standards and Technology (Secretary of Commerce) pursuant to Section 111 (d) of the Federal Property and Administrative Services Act of 1949, supplemented by the Computer Security Act 1987, Public Law 100-235, United States of America, the entire contents of which are incorporated by reference as though fully set forth herein.

If a cryptographic module is employed to create forgery-proof data records whose integrity is of interest to third parties, then an advantageous implementation consists of utilizing the cryptographic module in order to securely store cryptographic keys that serve to encrypt checking values inside the module and exclusively there. Known techniques in this context are, for example, so-called signature cards of the type issued by certification authorities or trust centers for purposes of creating digital signatures. These signature cards, configured as microprocessor chip cards, likewise contain a cryptographic module precisely in this microprocessor chip.

It is in such cryptographic modules that preferably one or more asymmetrical key pairs are stored, which are characterized in that encryptions generated with the so-called private key can only be reversed with the matching public key and in that encryptions generated with the public key can only be reversed with the matching private key. As the names indicate, public keys are intended for publication and widespread dissemination, in contrast to which private keys must not be divulged and, when they are used together with such a module, must not at any time leave these modules. Likewise stored in such modules are algorithms used, for instance, for checksum formation or, in the example of a digital signature, to create a so-called digital fingerprint or hash value that is characterized in that it maps any desired data content onto usually greatly abbreviated information in such a way that the result is irreversible and unambiguous, and in that different results are obtained for different data contents with which the algorithm is fed.

Using the hash value, a character string with cryptographic information is generated in the customer system. It is particularly advantageous for this character string to contain purchase data in plain text as well as cryptographic information that has been placed into buffer storage—especially the above-mentioned character string with cryptographic information—and also the generated hash value. This data will be referred to below as PayMark.

The PayMark is relayed to the described sending component, especially to the processing component that is contained in it, where it serves as confirmation of the creditworthiness of the party placing the order, thus allowing invoicing for the services provided.

The invoicing for the services provided can be carried out in various ways.

It is fundamentally possible to already redeem the PayMark in an e-commerce center at the time when the order is placed so as to initiate the payment procedure immediately after the order has been received.

However, it is likewise possible to undertake the invoicing at least in part after the goods have been handed over to the recipients.

In a first practical embodiment, this is done in that part of the monetary-value information is sent to the one or more dispatch points.

However, it is especially practical to incorporate part of the monetary-value information into the information carrier that is enclosed with the mailing.

This ensures that the invoicing is only effectuated once the recipient has obtained the goods at the dispatch point.

Aside from postal services—transportation of the information carrier to the recipient—the likewise above-mentioned writing onto the information carrier that can be enclosed with the mailing and the transfer of the goods to the dispatch point, or the delivery of the goods to the dispatch points, it is possible according to the invention for other services to be rendered and invoiced.

An especially practical example of another service is a printing service.

A particularly preferred presentation of the printing service consisting of the printing of a mailing and of a postal service consisting of the conveyance and delivery of the mailing will be elaborated on below. For purposes of printing the mailing, the order data generated by a terminal device should contain at least one image motif, while the delivery information indicated by the user allows the conveyance and delivery of the mailing to the intended recipient. Moreover, a user can enter a greeting text. Moreover, the image motif can also be, for example, an image-text combination containing, for instance, a greeting text.

In an especially preferred embodiment of the invention, the mailing that is to be printed and mailed is a postcard comprising an information carrier with information about the goods to be delivered as well as, optionally, monetary-value information, an image motif page and a text page with a greeting text and delivery information. The terminal device used here is, for instance, a computer or a mobile user device such as, for example, a mobile telephone.

It is particularly practical to establish the connection via an Internet protocol.

It has also proven to be practical to employ terminal devices that support the Multimedia Messaging Standard (MMS). The transmission of MMS data allows texts, melodies, images and video sequences to be sent, whereby the length of the message, the design and the file size of an MMS message are advantageously unlimited. Therefore, a user can employ a mobile terminal device to generate order data in the form of an MMS message consisting of at least one image motif and delivery information for a mailing such as, for example, a postcard. The image motif can be generated by the mobile terminal device itself or else it can be loaded onto it by another medium such as, for instance, a digital camera. Thus, a user can send any desired image motif in the form of a postcard, allowing for a wide range of design options. A greeting text can also be freely entered via the keypad of a mobile telephone, whereby only the maximum length of the text is limited.

In a particularly preferred embodiment of the invention, an invoicing component of the sending service system invoices a second invoicing component for the costs for storing the information about the goods to be delivered and/or for the provision of the goods to be delivered to at least one dispatch point and/or for the postal service as well as, optionally, for the printing service, whereby the second invoicing component belongs to a mobile system and/or to an e-commerce system. The costs incurred for the services rendered are settled by the invoicing component of the mobile system or of the e-commerce system which, in turn, invoices the user of the mobile system or of the e-commerce system. In an especially preferred embodiment of the invention, this user is a person who generated the order for the mailing at the terminal device. The invoicing can be effectuated, for example, in conjunction with the invoice for the mobile telephone that had been used or in conjunction with the invoicing for monetary-value information via the e-commerce center.

The e-commerce center is an integral part of the e-commerce system and allows invoicing for the services rendered.

In another embodiment of the invention, the invoicing is effectuated via a third party, whereby this other user assumes the role, for instance, of a payer (sponsor) and makes individual services or several of the described services available to other users, either completely free of charge or at a reduced rate.

Several components make up the inventive system for the automated generation of mailings, each having at least one information carrier, and for the performance of postal services in which a user can employ a terminal device to generate an order for a mailing to be created and sent.

The system consists essentially of at least one integral part of the e-commerce system and/or of a mobile system in conjunction with a sending service system. However, other components can also be integrated.

Fundamentally speaking, various combinations are a possibility here. In particular, the invention allows the integration of different systems.

In a practical manner, the sending service system is connected to at least one system that allows the transaction of payments.

In a particularly simple case, the use of a mobile system allows invoicing for the sending services rendered.

However, it is likewise practical to employ an e-commerce system. In particular, the use of the above-mentioned PayMarks is very advantageous because the described PayMarks make it possible to uncouple the confirmation of the presence of monetary-value information from the settlement of payments. For instance, when the PayMark is used, the validity of the monetary-value information can be verified in an accounting point (e-commerce center) separately from the submission of the monetary-value information.

Such a separation between the validity of the monetary-value information and the redemption of the monetary-value amount makes it possible, for example, after the verification of the validity (value) of the monetary-value information, to generate the information carrier and/or to initiate a transportation procedure for the mailing containing the information carrier. In this preferred embodiment, the monetary-value information is only relayed after the information carrier has been submitted at the dispatch point, so that it can be used for the accounting.

A mobile system is typically operated by a mobile telephone company in the form of a mobile telephone network with the appertaining components. In this context, several different mobile telephone networks can be connected to the sending service system. Each mobile system preferably consists of several mobile terminal devices to generate order data, a processing component to process order data and means to transmit the order data from the mobile terminal device to this processing component. The mobile system also has a database for storing data and a computing means for processing data as well as an invoicing component. The computing means is typically at least one server.

Typically, the mobile system encompasses a plurality of mobile terminal devices that are connected to one or more processing components via data-transmission routes such as a GSM network or an UTMS network.

A sending service system for ordering and performing services to generate the mailings and postal services (especially sending services) can be operated, for instance, by a postal service provider and can have various components that automate the procedures.

Such a system preferably consists of at least one interface for accepting order data, a database for data management and application management, an editing component to edit order data in order to create printing jobs, a printing production unit to generate a mailing and an invoicing component to invoice for the printing service and/or for the postal service.

The entire system according to the invention encompasses not only the e-commerce system and/or the mobile system and the sending service system but also a verification and processing component for processing order data and a database to store order data and means to receive and transmit data. The verification and processing component performs a verification and/or processes the order data in accordance with prescribed specifications. Preferably, the order data is filtered and validated in this process.

It has proven to be especially practical for the verification and processing component to also carry out a conversion of the order data into data that can be read by the interface of the sending service system. In an especially preferred embodiment of the invention, this interface of the sending service system is an http interface. Since MMS data of a mobile terminal device is typically transmitted via an MMS or SMTP protocol, the data is converted in the verification and processing component and relayed by means of the http protocol.

The verification and processing component can be located in the area of the e-commerce system or of the mobile system, or else in the area of the sending service system. However, it can also be configured as an independent component. The database, in conjunction with the verification and processing component, can likewise belong to various systems.

In an especially preferred embodiment of the invention, the results of the filtering and validation of the order data are stored in a database. Therefore, the data is available for further process steps. These include, for example, the notification of the users if it was not possible to carry out an order for the printing and sending of a mailing. This also contains information to the effect that no invoicing or only partial invoicing will be carried out by an invoicing component for an order that was generated but that could not be executed.

The method according to the invention and the appertaining system for executing the method entail several advantages. For one thing, they allow users of the system to place orders for the sending of individual mailings, a process in which users themselves have a great deal of freedom in designing the mailing.

The goods to be delivered can also be selected in a variable manner. It is, however, advantageous to provide a database relating to generally available goods and to goods that can be made available at individual dispatch points.

In an especially practical embodiment of the invention, users can select among predefined goods as well as among goods they select themselves and can then provide them for pick-up at the dispatch points.

Advantageously, the information carrier contains information about the goods, whereby, in an especially preferred embodiment of the invention, a verification procedure is also carried out as to whether the provision of the goods at one or more dispatch points has already taken place and/or whether this is possible within a definable time interval.

The design that is printed onto the mailing can likewise be configured in a flexible manner.

Users can not only choose from among a given selection of image motifs but they can also upload images that they have generated themselves or images that they have generated by other means such as digital cameras. A greeting text can also be freely entered by users, except that it is limited to a maximum length. Moreover, users generate an order using the terminal device virtually independently of their location. Moreover, there is no need for any auxiliary means, but rather, they can make use of existing functions without a need for any modifications.

Moreover, the invoicing for the costs incurred for the services ordered by users is not associated with any extra effort on the part of users since the invoicing preferably takes place via the users' mobile telephone bill, via a deduction from a pre-paid card or via other modalities for transmitting monetary-value information, especially via the use of an e-commerce center or of PayMarks. Consequently, users do not have to sign up for a specific payment system or have to provide personal data which they might not want to provide for a one-time sending of a mailing.

However, it is likewise possible to employ the invention for the mass sending of mailings provided with information carriers.

In this case, the above-mentioned process steps can be carried out accordingly, whereby, however, it is particularly practical to use standardized Internet protocols and interfaces between databases containing information about a plurality of recipients as well as about a plurality of goods to be delivered.

The configuration of the system according to the invention and the execution of the method according to the invention can be carried out with a plurality of components.

However, special preference is given to the components shown in the figures.

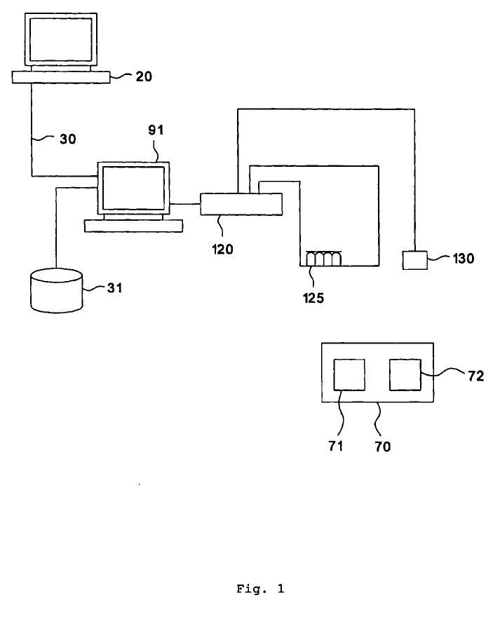

The basic principle of a particularly preferred order processing according to the invention as well as of a particularly preferred generation of mailings according to the invention is shown in FIG. 1.

An order component 20 is connected to a linking element 91 via an interface 30 of the sending service system. This linking element 91 is also connected to a database 31 of the sending service system as well as to a writing device.

In the case presented here, the writing device is configured as an RFID control unit 120.

The RFID control unit 120 is connected to an RFID antenna 125.

Moreover, the writing device is connected to a printing head 130, for example, an inkjet printing head, a laser printer or a thermal transfer printer.

A sending component according to the invention is formed by these described constituents of the system.

The embodiment shown—with its RFID antenna 125 for writing onto an information carrier and with a printing head 130 for printing onto a mailing 70—is particularly practical for application cases in which a lot of information is to be stored in the information carrier or in which the information carrier—preferably a transponder—is configured in such a way that it can be read out or written on from a considerable distance (typically about 30 cm to 10 m).

However, it is likewise possible to implement a simpler embodiment of the sending component. Such a simpler embodiment of the sending component can provide, for example, that the printing head 130 can also print information about at least one item to be delivered onto the mailing 70.

By means of the sending component according to the invention, the likewise inventive generation of a mailing provided with an information carrier relating to the goods to be delivered can take place as described below by way of an example:

Data about at least one item to be delivered and about at least one recipient of the goods is processed in the order component 20.

This data is transmitted to the control component 91 via the interface 30.

A query to a database 31 of the sending service system can ascertain the correctness of the mailing address and/or the availability of the goods to be delivered, especially their availability at one or more intended dispatch points.

The control component 91 of the sending service system, for example, a computer server, verifies the availability of the goods by querying the database 31. The control component 91 is also connected via the interface 30 to the order component 20, for instance, a computer connected via the Internet or a mobile telephone wirelessly connected via a mobile system.

In the preferred embodiment presented here, the mailing 70 has an information carrier 71 as well as address data 72.

In the especially preferred embodiment presented here, the information carrier 71 is an RFID tag.

An RFID tag is a transponder that contains identification information.

Both active as well as passive transponders can be employed.

The use of active transponders entails the advantage that they can be read out or written on from greater distances and that they are capable of activating passive reading units.

The use of active transponders entails the special advantage that they are particularly small and lightweight, so that they can be integrated very easily into mailings, especially into postcards.

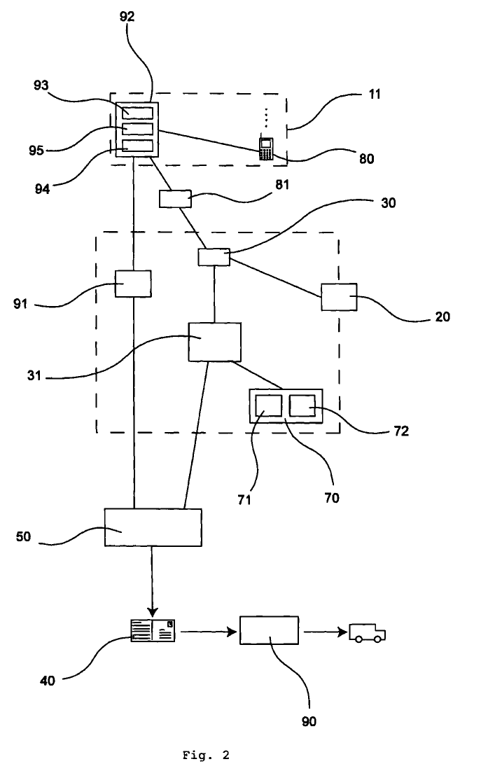

FIG. 2 shows an especially preferred embodiment of the inventive system for the automated ordering of printing services and postal services via a mobile terminal device 80. The system consists of at least one sending service system 10 and of a mobile system 11. In the figure, the appertaining systems are delineated with respect to other components by broken lines in order to illustrate which components are advantageous in order to operate the individual systems. However, various components can also be removed or additionally integrated.

The core element of the sending service system 10 is made up of a database 31 that serves to store data and to retrieve data and that is connected to various components of the system. The entire data management is preferably implemented in a relational database. An oracle database, for instance, has proven to be advantageous as a database. The database is connected to an interface 30 by means of which data from various order components can be received. In addition to the generation of order data via a terminal device 80, for example, orders can be placed via a website with an appertaining server. Such alternative means for generating order data are designated with the reference numeral 20 in the figure. It is particularly advantageous if the order data of various order components can be received by the sending service system via the shared interface 30 using a uniform protocol. An http interface, for instance, can be employed for this purpose.

The database 31 is also connected to an editing component to generate printing jobs and to a printing production unit 50 to which the generated printing jobs are transmitted so that the mailings can be produced. The system 10 also comprises an invoicing component 91 to invoice for the printing service and for the postal service provided by the system.

The editing component of the sending service system 10 preferably comprises at least two components that are designated here as back-end services. One of these components serves to create the image motif while the other component generates preview data and printing data. The printing production unit 50 can be an integral part of the sending service system or else it can be connected to the system modularly. For example, these can be one or more printing service providers that print mailings on behalf of the system. The printing production unit generates a mailing 40 on the basis of the received data and then transfers the mailing to a distribution system 90. The distribution system can comprise various sorting and distribution means for delivering the mailing to a recipient on the basis of the delivery information provided by the user. In an especially preferred embodiment of the invention, a connection exists between an invoicing component and the printing production 50 and/or the writing onto the information carrier 71, so that a message can be sent to this invoicing component about the storage of the information in the information carrier 71 and optionally about the completion of a printing job and/or a shipment.

An especially advantageous part of the system according to the invention consists of a mobile system 11. In this context, one or more mobile systems can be connected to the sending service system 10. Each mobile system preferably consists of at least one mobile terminal device 80 to generate order data, of a processing component 92 to process the order data and of means to transmit order data from the mobile terminal device to this processing component. Typically, a mobile system comprises a plurality of mobile terminal devices that are connected to one or more processing components via data-transmission routes such as a GSM network or an UTMS network.

The processing component can be, for instance, a Mobile Switching Service Center (MSC) which, together with other components such as databases, typically performs the actual task of the telephone infrastructure. The recording of invoicing data can take place, for example, in an invoicing component 93. A processing component of the mobile system can also have a message center by means of which Short Message Service (SMS) messages, Multi Media Message (MMS) messages, voice messages of a voicemail box, faxes or e-mails can all be processed.

In the case of the especially preferred embodiment of the method according to the invention presented here, a terminal device 80 is used to generate an order for a printing service in conjunction with a postal service. This is preferably an order for sending a postcard. For purposes of doing so, a user selects an image motif to be printed on the postcard and provides delivery information for sending the card. The image motif can be selected in various ways. For one thing, the user can be offered a selection of image motifs from which he can make a choice. The image motif selected can be shown, for example, on a display of the mobile device. However, it is particularly advantageous for the user to be able to select a freely definable image motif for a mailing that is going to be sent. For example, in order to do so, the user can generate an image with the mobile terminal device, using the device as a camera in this process. The user can also upload an image generated by another medium.

The user enters the delivery information needed for an order, for example, via the keypad of the mobile device. The delivery information comprises at least the name of the recipient and the address containing the street name, postal code and city. In addition, the user can enter a greeting text. There is a limit to the length of this text. Advantageously, the maximum length of the text is displayed to the user.

The order data thus generated is transmitted to a processing component 92 of the mobile system. The transmission is carried out via a mobile telephone network. The format of the transmitted data is preferably the MMS format. Within the processing component, the MMS data is stored on computing means 94 such as servers or transmitting computers. These transmitting computers are preferably computers with permanent IP addresses. The numeric address of a network subscriber under TCP/IP is designated as an IP address. TCP/IP are the two protocols that ensure the data exchange in networks, upon which Internet services such as WWW, FTP, e-mail, News, etc. are based. TCP is the abbreviation for Transmission Control Protocol. IP is the abbreviation for Internet Protocol.

The transmitting computers 94 transmit the received MMS data to the verification and processing component 81. Since the verification and processing component can belong to a mobile system 11, to a sending service system 10 or to a system of its own, it is shown in FIG. 2 between the systems.

The verification and processing component 81 receives the MMS data from the transmitting computers. The transmission preferably takes place via a coordinated protocol such as the SMTP protocol. In a first step, the MMS data is filtered out. For instance, only MMS data from computers with defined IP addresses or MMS data that also contains image information is accepted. If the MMS data does not contain any image information, it can either be declared to be erroneous or else the missing image motif is replaced by a standard image motif. Moreover, the filters can be spam filters that filter out undesired or unsolicited advertising orders or mass-mailing orders. Furthermore, MMS data without images and MMS data that does not meet defined size specifications can be filtered out. In an especially preferred embodiment of the invention, MMS texts that do not contain defined characters or character sequences are likewise sorted out. For example, texts without postal code or without separators can be sorted out.

In a second step, the text information of the MMS data undergoes a validation. The validation can comprise the checking and correction of the syntax and/or semantics. The syntax can be adapted to the user input and results, for example, in <name1>, <name2>, <street>, <postal code> and <text of maximum length>.

The syntax validation can also comprise an automatic syntax correction that is employed in defined cases. For instance, the separator “semicolon” is converted into the separator “comma” which, according to a syntax rule, can be obligatory. Moreover, the syntax validation checks the text length and shortens the text if it has exceeded the permissible number of characters. Since erroneous inputs are common via mobile terminal devices, another optimization has proven to be quite practical when it comes to the address. On the basis of a logic that locates the postal code, city and the street name in the MMS message, if the syntax or semantics of an MMS message are found to be incorrect, an attempt is made to identify the city or the postal code and the street in question. These undergo an automatic address correction procedure based on a street directory. For example, a street directory of Germany exists by means of which detected delivery information of an MMS message can be automatically corrected if a match is found.

Syntactically correct texts are broken down into their logical constituents and subsequently stored in a database. The database can likewise be located in the mobile system, in the sending service system or in another area. Syntactically incorrect MMS data that cannot be automatically corrected is designated as erroneous and likewise stored for purposes of a manual correction that might be carried out.

In another step, the image information of the MMS data is automatically edited. Depending on the incoming format, the images are rotated, scaled or the dpi number is increased. Moreover, they undergo a focusing procedure. The graphics routines needed for this purpose are provided, for example, by an application of the type offered by the Adobe company.

In a last step, the edited data is transmitted to the interface 30 of the sending service system. If an error occurs during the transmission of the data and/or if the interface reports back an error, then this data is likewise flagged as being erroneous in the database and, if these are protocol or transfer errors, this data is resent periodically.

Erroneous data is identified by an automatic process in the database, whereby the sender is ascertained on the basis of an MSISDN number (Mobile Subscriber ISDN). The MSISDN is a subscriber number under which a subscriber can be reached. Thus, the sender receives a message that informs him about the error that has occurred and provides general or specific instructions for the next submission by the customer. This notification is made, for example, in the form of an SMS or MMS.

The interface 30 transfers the order data to an editing component of the sending service system 10 which, in a particularly preferred embodiment of the invention, comprises two back-end services that preferably generate the PDF files that are needed for the subsequent printing production 50.

A suitable back-end service generates data about the goods information that is to be stored on the information carrier 71, and optionally also other information needed to generate printing data on the basis of an image motif.

A back-end service for producing image motifs generates printing data for the image motif. Another component for producing text layouts generates a print PDF of the text page. The printing files are preferably generated as PDF files in a special postcard format that has, for instance, crop marks and an additional margin, thus simplifying the cutting of the postcard on the printed sheets that have been produced.

The editing and conversion of data for the production of a postcard will be described below by way of an example. In this context, it has proven to be advantageous that the text for a postcard to be produced can be submitted in three formats, namely, plain text, RTF (Rich Text Format) and XML (Extensible Markup Language).

The XML format corresponds to the printing instructions as they are preferably processed on the part of the card production. In this manner, single-line text blocks, lines and images can be positioned with millimeter precision. For this reason, a conversion into the XML format is preferable.

This is why the plain text format is converted into an XML format in the editing component 70 so that a layout-production core only has to be able to process the XML format. The RTF format is likewise converted into XML by a module.

The plain text format corresponds to normal, unformatted text and it is supplied by the mobile terminal device 80 when the user enters the text into this terminal. Here, as a rule, the typeface and font size of the entire text of the card can be transferred by the front end. Preferably, the entered text is positioned line-by-line by the back-end services of the editing component. If a text line is wider than the text field of a postcard, then a line break is inserted at a suitable blank space.

Preferably, the JPG format is supported for the image motif of a postcard. If the JPG image contains information about its resolution (in dpi), it is advantageous to use this information in order to determine the actual size of the image (in mm). If no information about the resolution is available, then advantageously a standard resolution is assumed. The standard resolution can be, for example, 72 dpi.

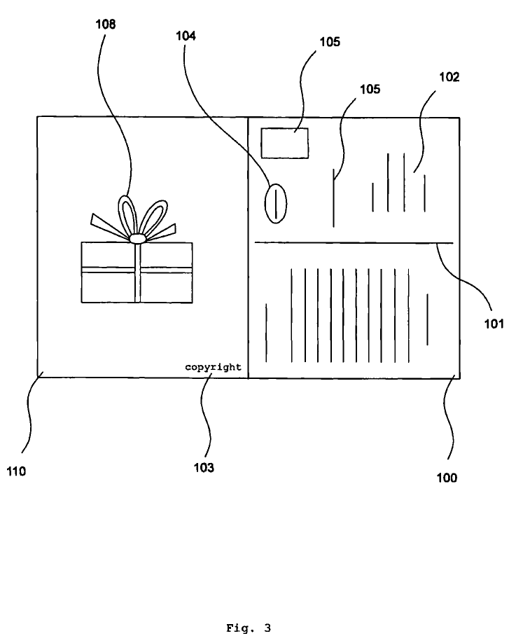

The documents to be printed consist of a production text page 100 and a production image motif page 110, as shown side-by-side in FIG. 3. The production text page 100 can contain, for example, elements such as the card text 101, delivery information (recipient address) 102, information about copyrights 103, a company logo 104, a postage indicium 105 or a postage stamp, a pre-paid postage mark 106 and/or a graphic element in the form of a vertical line 107 that divides the postcard into two sections.

It is especially practical for the postage indicium 105 to contain encrypted information, whereby, in a particularly preferred embodiment, the encrypted information is at least partially generated and/or processed and/or placed into buffer storage, in a cryptographic module.

An especially preferred embodiment provides that the same cryptographic module that is used to generate digital postage indicia is also employed to encrypt information about the goods.

Company logos or other graphics that are specific to a given customer can also be integrated, for example, into the image motif side of the postcard. The layout of this page can be predefined, whereby advantageously, certain parameters such as margins and distances can be configured.

Fonts that are not standard fonts of the PDF format and that are available in TrueType format are embedded into the PDF file and can thus be made available to the printer.

If users of the system upload their own image motif, then a PDF file is generated that contains the image motif that was uploaded by the customer and that is positioned according to certain rules. If an image is not uploaded in a certain color space, it can be converted into the requisite color space. Since preference is given to the CMYK color space when it comes to printing postcards, an image uploaded in the RGB color space is converted into the CMYK color space for purposes of the PDF production. For a preview image (JPG) that is to be generated, the RGB color space can be retained, or else the image can be converted into the RGB color space if CMYK was uploaded.

The back-end services analyze the image uploaded by the user and generate a PDF file on this basis for the production. The scaling/positioning is not done by the back-end service, but rather, it is incorporated into the PDF file with the appropriate parameters (width, height, position). This allows the image to be optimally calculated by means of a RIP (Raster Image Processor). The image for the production is converted into the CMYK color model before its placement in the PDF file.

The editing component transfers the printing jobs generated by the back-end services to a printing production unit 50 that executes the printing jobs. This printing production component is preferably configured in such a way that it can generate various postal products. Thus, for example, it can print postcards or letters. In this context, with an eye towards being able to generate a wide array of postal products as flexibly as possible, it can be practical to connect several printing production components to the system 10 and/or to integrate them into the system. Thus a given printing production unit can generate a specific postal product. These printing production units can be the system's own components or else a connected printing service provider that accepts printing jobs, executes them and transfers them to a distribution system 90.

In the eventuality that the user has chosen an image motif for a postcard from a given collection, these image motifs are present in a local memory of the printing production unit 50 as preripped PostScript files with crop marks. The PostScript files have, for example, the following format: 151.5 mm×108 mm. The crop marks are configured in such a way that the image is cropped to a format of 148.5 mm×105 mm. For production purposes, the printing production unit 50 needs a storage reference to the local file in order to generate the printing instructions for the printer.

There are preripped PostScript files on the collator for all of the text pages. These files contain, for example, the postage indicium, the vertical line in the middle of the postcard and the prepaid postage mark. All other texts (copyright, text field, address field) are located in the PDF file that was generated by the back-end services. Moreover, for reprints, an unambiguous identification of the mailing is printed on the mailing within the printing data flow.

The invoicing for the printing and/or mailing service performed by the sending service system 10 is carried out via an invoicing component 91 of the sending service system. The invoicing component invoices a second invoicing component 92 which belongs to the mobile system 11, for the incurred costs. The second invoicing component settles this invoice and, in turn, charges the user of the mobile terminal device who generated the order. The invoicing is preferably carried out via the mobile telephone bill of the user in question. Another possibility is invoicing through a deduction of monetary amounts from a prepaid card.

The costs for a printed and transported mailing can also be charged to another user, for example, if a sponsor participates in a mobile system in such a way as to offer other users a service for sending mailings that is partially or completely free of charge.

Alternatively, the invoicing can be carried out only at the time when the goods are picked up at the dispatch point.

As already mentioned above, the mailings contain information about the dispatch point(s).

In a few areas of application of the invention, it is practical for the information about the dispatch point(s) to be as unambiguous as possible. This is particularly advantageous if a fast and reliable handing over of the goods to the recipients is of great importance.

Other preferred embodiments of the invention make it possible to give the recipient of the mailing an incentive to visit various places with the information carrier.

An incentive to visit various places consists of offering rewards in one or more of the selected places.

In order to give recipients an incentive to visit various places, also when one or a few rewards are offered, it is advantageous to keep the information about the places as generalized as possible.

The specificity of the information about the goods can also vary. Particularly for those cases where the recipient is the same as the ordering party, it is practical to have application cases in which the recipient has very precise knowledge about the goods that are to be sent to him.

In this manner, the invention can be integrated, for example, into online ordering systems so that the latter can be improved through a very simple and practical delivery of the goods to the recipient.

Other preferred embodiments of the invention comprise more generalized information about the goods to be delivered and about the rewards to be given.

In order to motivate the recipient of the mailing to visit several pre-definable places—optionally also several dispatch points—the information about the dispatch points can also be expressed in a generalized manner.

For example, the information about the dispatch point(s) can alert the recipients of the mailing to a prize that awaits them in one of the following businesses:
Flower Shop F
Jewelry Shop J
Department Store D
Liquor Store L

It is also a practical approach for the awarding of a prize to be a function of the person's having visited one or more places.

In addition to the above-mentioned example of the specified places to be visited, it is alternatively possible to give recipients of the mailings the possibility to choose which one of the suggested places they will visit.

For instance, the recipient is prompted to visit a few of several departments of a department store (without limiting the generality, for example, eight out of twenty departments).

In order to allow a flexible awarding of a prize, it is practical to store at least one random number in the information carrier.

In a practical embodiment of the invention, the random number serves as information about the goods to be delivered as defined by the invention.

The use of reading devices in selected places to be visited makes it possible to ascertain a visit of the places by the recipients of the information carrier and to give them a reward for visiting that place or another selected place.

As a result, it becomes attractive for the recipient of a mailing to visit at least individual places of a service provider and/or of a commercial establishment.

For this purpose, it is practical to employ transponders as information carriers.

In selected service providers and/or commercial establishments (that are participating in the rewards system according to the invention), devices are arranged that detect the presence of the recipient of the mailing by means of the transponder.

Optionally, the recipient of the mailing can be identified on the basis of the information data stored in the transponder.

Such detection of the identity is very practical especially in order to use the acquired data in a loyalty program.

As an alternative, however, it is likewise possible that the information carrier does not store any information about the recipient or else not any information about the recipient that can be evaluated by the reading units in those places.

This increases the privacy protection and takes into account the privacy-protection concerns that the recipient of the mailing might have.

Particularly advantageous embodiments of the invention comprise selection options—which might be centrally stored—available to the recipient of the mailing as to whether he wants information that identifies him to be stored on the information carrier.

An especially advantageous embodiment of the invention provides for the recipient of the mailing to be able to chose whether information about his identity should be incorporated into the information carrier.

In a practical manner, this is done by storing a digital pre-information in the database 31.

Storing information about the privacy-protection requirements of the recipient in the database 31 makes it possible to program the microprocessor chips contained in the information carriers in such a way that they correspond to the privacy-protection concerns of the recipient in question.

For instance, it is possible to equip the microprocessor chips with a logical switch that is configured in such a manner that it allows a decision to be made as to whether to store or not to store movement information.

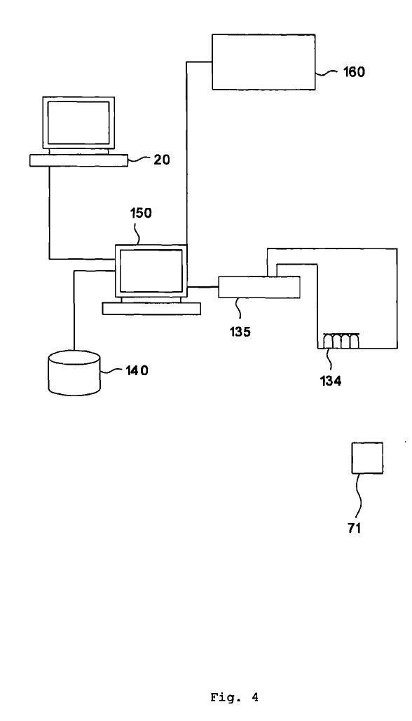

The association of the rewards of the rewards system and the releasing of goods are preferably carried out in the dispatch point shown in FIG. 4.

Information about the goods to be delivered as well as optionally information about the movements of the recipient—if such a detection was activated—are compiled in the dispatch point.

Advantageously, the signal emitter 160 is configured in such a way that it makes the association of the item or goods to be delivered on the basis of the information stored in the information carrier.

The information stored in the information carrier can be, for instance, the above-mentioned information incorporated during the creation of the mailing and optionally, other additional information.

An example of additional information is information about the places visited.

As an alternative, information about the places visited can be stored.

On the basis of the stored information, the signal emitter 160 takes over the task of associating the goods to be delivered and optionally, an additional prize as a reward for visiting selected places.

The association of the reward as a function of the visit to certain places can be done in various ways. For example, in a first embodiment, it can be evaluated whether the recipient of the mailing with the information carrier has visited at least one selected place.

In this context, it is advantageous to configure the transponders in such a way that they have a writeable memory that is sufficiently large to store the presence-related information.

In a practical refinement, the duration of the stay of the recipient of the mailing in at least one of the places is recorded.

In this manner, the giving of the reward and/or the amount of the reward can be made dependent on the duration of the stay.

Even though it is particularly advantageous to combine the handing over of the goods with the information about a visit to certain places, the invention can also be implemented independently of this information.

The independence and the flexibility of these variants of the invention will be presented below in a follow-up to of the example of the four dispatch points, namely, Flower Shop F, Jewelry Shop J, Department Store D, Liquor Store L.

When the dispatch points are visited, information contained in the information carrier is read out and transmitted to the signal emitter 160.

In an especially preferred embodiment, the dispatch point is configured in such a way that it contains an RFID antenna 134 and an RFID reading device 135, whereby the RFID antenna 134 and the RFID reading device 135 are configured such that they can read the information stored in the information carrier 71 and transmit said information to a server 150.

The server 150 allows several components to be linked.

It is advantageous for the server 150 to be connected to the order component 20.

In this manner, for instance, the order data can be transmitted to the server. Moreover, this also makes it possible to transmit information to the order component 20 about the transaction of the goods delivery, especially the handing over of the ordered goods to the recipient.

Furthermore, it is advantageous to connect the server 150 to a database 140.

In an especially preferred embodiment, the database contains information about the goods on hand and/or the goods delivered as well as about pick-up information.

Moreover, it is a practical approach to connect the server 150 to the signal emitter 160.

For example, at one of the places—e.g. the Liquor Store L—it is ascertained whether the goods information and/or the random number match a virtual lottery number entitling the bearer to receive a reward, for instance, a bottle of wine.

The invention also comprises a rewards system in which movement data of the information carrier is employed for an association of rewards.

An especially preferred embodiment of the rewards system and of the other components of the invention provides for the information carrier to be configured as an RFID tag for this purpose.

The use of random numbers for the association of the prizes is likewise advantageous.

Another preferred embodiment of the invention provides for the movement data to be linked to the information about the goods to be delivered.

This allows a reward—also in the virtual form of monetary-value information—to be associated with the recipient as a function of the goods to be delivered and of the movement data.

It is also possible to evaluate the purchasing behavior of the customer and to take this into consideration when rewards are handed out.

The purchasing behavior of the customer is evaluated in a form that ensures privacy protection. In particular, it is practical to check whether stored information is present indicating whether the customer consents to the evaluation of his purchasing behavior.

The purchasing behavior of the customer can comprise one or more of the following aspects: type and/or number of articles bought, information about the payment behavior as well as, optionally, the frequency of purchases.

The invention also comprises the integration of elements of the rewards system into other components of the invention, especially into the inventive method for sending goods, the inventive method for handing over goods and the corresponding systems and devices.

It is also advantageous to provide means for electronically monitoring the movements of the information carriers within the places or among the various places.

It is likewise practical to detect the presence of the information carrier in at least one dispatch point.

It is particularly advantageous to undertake an association of an item to be handed over and/or an association of a reward on the basis of the ascertained presence information indicating the presence of the information carrier in the dispatch point.

In this context, the association of the reward can also be effectuated like the handing over of the goods. It is, however, likewise possible to hand out virtual rewards, particularly in the form of monetary-value information.

It is especially practical to evaluate information stored in the information carrier.

In particular, an evaluation is made of the information about the goods to be delivered stored in the information carrier.

It is also practical to acquire and/or evaluate information about the identity of the information carrier.

In order for the handing over of the goods to be carried out in the simplest and most reliable manner possible, it is practical to configure the dispatch point as shown in FIG. 4.

The reading device shown in FIG. 4 (especially an RFID reading device or a reading device for barcodes) transmits information about data contents to the server 150.

The server 150 controls a signal emitter 160.

The signal emitter 160 is configured in such a manner that it can effectuate the provision of the goods to be delivered and/or—some kind of—reward.

The association is made on the basis of the information stored in the information carrier 71.

Examples of the information stored in the information carrier 71 include information about the identity of the recipient of the mailing and/or about the goods to be delivered and/or movement data.

The signal emitter is configured in such a way that it can effectuate the association of the goods and/or—some kind of—reward, taking into consideration this information or at least some of this information.

In order to allow an unambiguous association of the goods and/or of—some kind of—reward to the recipient, the signal emitter 160 controls an appropriate output device.

In a first simple embodiment, the output device comprises an optical display that is controlled by the signal emitter.

The optical display can contain, for example, information about goods so that an operator, for instance, receives this information.

It is particularly advantageous to configure the signal emitter in such a way that it initiates an automated association of the goods and/or of—some kind of—reward.

This can be done, for example, in that the signal emitter controls the opening of a compartment.

This can be, for example, a compartment of an electronic parcel deposit box facility and/or of a goods storage facility.

In this context, the invention can be provided with several dispatch points.

By the same token that the dispatch point can be configured as a locker facility, other embodiments are likewise practical such as, for instance, installations or facilities that use conveyor belts or that function according to the cyclic elevator principle.

The components presented permit various implementations of the invention.

First of all, a selection is made of one or more suitable recipients for the mailing.

The recipient can be selected either according to individualized criteria or according to standardized criteria.

Thus, for instance, it is likewise possible to systematically select a recipient for pre-definable goods or also to provide a plurality of recipients for several, preferably similar, goods.

The information about the goods is very concrete in the individual embodiments of the invention, so that an unambiguous association of a given item with a recipient is ensured.

Other likewise advantageous embodiments of the invention, in contrast, provide that the goods are only associated with the recipient at a later point in time.

Here, it is particularly advantageous for the association to be made as a function of identification information stored in the information carrier.

The identification information is preferably configured as category information that allows an item to be associated with the recipient as a function of external conditions (stipulations).

For instance, the identification information can contain information about whether the recipient of the mailing is a member of a definable group, for example, member of a club or of an especially preferred customer group of a company.

In this context, the identification information allows an association as a function of affiliation with a group and/or as a function of at least one other association parameter.

An especially preferred example of such an association parameter is the availability of the goods in the area of the dispatch point.

Another practical association parameter is a predefinable period of time.

It is advantageous to specify the time span as a function of operating parameters.

It is also advantageous to hand out different goods to recipients having the same identification information at different time intervals.

In accordance with the various embodiment possibilities, the invention can be configured as an improvement of a known goods-delivery system and also as a rewards system.

In an especially preferred embodiment, the configuration as a rewards system takes into account ascertained behavior data of the recipient of the mailing.

In particular, insofar as this is desired by the recipients, it is a practical approach to acquire data about their movements within various places of a service provider (especially a department store) or at various service providers (for example, several department stores) and to associate this with a reward as a function of the information thus acquired.

The rewards can be in the form of goods and/or monetary-value information.

In an embodiment of the invention as a refinement of a goods-delivery system as well as in an embodiment of the invention as a rewards system that can be combined with this, it is advantageous to inform the recipient of the mailing by means of the mailing itself as well as by means of other suitable notification means about the goods being made available to him or about the goods that are to be given to him as a reward.

This attracts the attention of the recipient of the mailing to an even greater extent.

These notifications motivate the recipient of the mailing to visit at least some of the desired places.

These places are, for example, spaces equipped with electronic detection means for the information carriers.

As a function of the operating parameters desired in each case, the places to be visited are, for instance, a department store, a shop, a department of a department store or shop or even an individual display or an individual shelf.

Moreover, it is likewise possible for the dispatch points to be configured to detect the presence and/or the identity of the information carrier.

In this manner, it is possible, for example, to hand out rewards immediately after a pre-specifiable number of places have been visited.

The reward can be given out in addition to goods already ordered or as an independent reward, depending on the pre-definable parameters.

This makes it possible to further raise the motivation of the recipients of the mailing to visit the places in question.

Moreover, the especially preferred embodiment of the invention presented here allows additional effects to be achieved.

For example, the attention of the recipient of the mailing is aroused by the electronic notification sent to him before the mailing is received.

Moreover, the preceding information about the mailing provided with an information carrier conveys to the recipient of the mailing a sense of the value of the specific mailing and of mailings in general.

When the mailing is received, the information about the value of mailings is further enhanced by the information about the reward that can be obtained by means of the information carrier.

Besides, when the goods are pictured on the mailing, the recipient of the mailing perceives the visual and tactile quality of mailings.

Therefore, the invention achieves the additional effect of associating mailings with a positive emotional experience.

Particularly by repeatedly sending out mailings associated with rewards, it is possible to enhance the identification of the recipient of the mailing with the sender of the mailing and with the postal service provider that transports the mailings.

In particular, this motivates the recipient of the mailing to open his mailbox in a good mood so that he is more receptive towards other mailings present in his mailbox.

Therefore, the invention is suitable not only for the sending of goods but also to present the postal service provider in a positive light.

Furthermore, it is made clear to recipients of the mailings that the use of information carriers, especially of transponders, can also be advantageous for them.

Consequently, the invention helps to increase the level of acceptance of information carriers in general and of transponders in particular.

Also for department stores, it is advantageous to set up the above-mentioned places and/or dispatch points.

As a result, these places are perceived by the recipients of mailings as places where they receive goods and/or rewards.

For the operators of such commercial establishments, this not only has a positive advertising effect but also the direct effect that the recipients of mailings are prompted to visit the commercial establishments in question.

Therefore, the embodiments of the invention presented here are equally advantageous for the following users: those placing the orders for the mailings, postal service providers, recipients of the mailings, producers of information carriers (especially of transponders) and commercial establishments.

### LIST OF REFERENCE NUMERALS

10 sending service system
11 mobile system
20 order component
30 interface of the sending service system
31 database of the sending service system
40 mailing
50 printing production unit
70 editing component, back-end services
71 information carrier
72 address data
80 terminal device
81 verification and processing component
90 distribution system
91 linking element
92 processing component of the mobile system/second invoicing component
93 invoicing component of the mobile system
94 computing means of the mobile system, transmitting computer, server
95 database of the mobile system
100 text page
101 card text
102 delivery information
103 information about copyrights
104 company logo
105 postage indicium, postage stamp
106 pre-paid postage mark
107 graphic elements to divide the postcard
108 post card image motif
110 image motif page
120 RFID control unit
125 writing component (RFID antenna)
130 printing component
134 RFID antenna
135 RFID reading device
140 database
150 server
160 signal emitter

1-21. (canceled)

22. A system for sending an information carrier to a recipient, comprising:
an editing component that enables editing mailing address data of the recipient in order to create a printing job;
an interface to transmit the mailing address data to a printing component that is adapted to print at least information about one or more dispatch points onto a mailing and/or onto a communication that can be enclosed with the mailing;
a database containing information about goods to be delivered and about at least one dispatch point intended for the delivery of the goods;
a linking element that is adapted to link information about the goods to be delivered to the mailing address data of the recipient;
an interface to transmit information about the dispatch points to the printing component;
a writing component with which information about goods to be delivered is written onto an information carrier in machine-readable form; and
a goods delivery system that comprises a logistics system in which information pertaining to the goods to be delivered is sent with the information carrier, wherein the information carrier is sent to a different mailing address than the goods that are to be delivered by the goods delivery system, and wherein the goods delivery system comprises at least one dispatch point at which the goods to be delivered are present, and wherein the dispatch point contains a signal emitter for the association of the goods to be delivered on the basis of the machine-readable information.

23. The system recited in claim 22, wherein the writing component is adapted to print a two-dimensional or three-dimensional code as machine-readable information and wherein a printed object contains graphically recognizable information about the goods to be delivered.

24. The system recited in claim 22, wherein the printing component comprises the writing component.

25. The system recited in claim 22, wherein the writing component contains a transmitter for electromagnetic radiation and wherein a transponder that is adapted to be attached to the mailing is an information carrier for the information about the goods to be delivered.

26. The system recited in claim 22, wherein the signal emitter is connected to a reading unit to read the information about the goods to be delivered stored in a transponder.

27. The system recited in claim 22, wherein the signal emitter is connected to a reading device to facilitate machine-controllable reading of the machine-readable information.

28. The system recited in claim 22, wherein the signal emitter is connected to a display that is suitable to indicate the goods to be delivered.

29. The system recited in claim 28, wherein the display creates a graphic display of the goods to be delivered or of information indicating the goods to be delivered.

30. The system recited in claim 28, wherein the display is configured to display information about a position of the goods to be delivered in the dispatch point.

31. A method for sending an information carrier to a recipient via a system that includes an editing component that facilitates editing mailing address data of the recipient in order to create a printing job, an interface to transmit the mailing address data to a printing component that is adapted to print onto a mailing and/or onto a communication that can be enclosed with the mailing, the method comprising:
storing information about goods to be delivered and about at least one dispatch point provided for the delivery of goods in a database;
linking information about the goods to be delivered to the mailing address data of the recipient;
transmitting information about the dispatch points to the printing component;
printing onto the mailing or onto an address data carrier that can be attached to the mailing;
printing information about one or more dispatch points onto the mailing and/or onto the communication that can be enclosed with the mailing,
writing information about the goods to be delivered onto the information carrier in machine-readable form; and
making an association of the goods to be delivered at a dispatch point on the basis of the machine-readable information.

32. The method recited in claim 31, comprising notifying the recipient in the case of at least one sending event.

33. The method recited in claim 32, wherein the notification of the recipient takes place in a manner related to the time when the information was stored on the information carrier.

34. The method recited in claim 32, comprising:
checking whether the mailing has been dropped off in a mail-processing system; and
notifying the recipient when the mailing has been dropped of drop-off in a mail-processing system.

35. The method recited in claim 32, comprising providing an electronic notification to the recipient when the mailing is placed into a mailbox of the recipient.

36. The method recited in claim 31, comprising carrying out an identification of the mailing and/or of the information carrier contained in it while the mailing is being processed in a mail-processing machine, the notification of the recipient being carried out on the basis of the identification.

37. A sending component, comprising:
an interface to a database containing information about goods to be delivered and about at least one dispatch point intended for the delivery of the goods;
a linking element that is adapted to link information about at least one item to be delivered to mailing address data of a recipient who is intended to receive the sent goods;
an editing component that facilitates editing the mailing address data of the recipient in order to create a printing job;
a writing component that is adapted to write information about the goods to be delivered onto an information carrier in machine-readable form; and
a device that is adapted to provide the mailing with a postage indicium.

38. The sending component recited in claim 37, comprising a cryptographic module that is configured to allow cryptographic information relating to the postage indicium and cryptographic information relating to the goods to be delivered to be at least partially generated and/or processed and/or placed into buffer storage by the cryptographic module.

39. A dispatch point for goods, comprising:
a reading unit adapted to acquire information about goods to be delivered, the information being acquired from at least one information carrier, wherein the reading unit comprises a signal emitter to associate the goods to be delivered on the basis of the acquired information.

40. The dispatch point recited in claim 39, wherein the reading unit is adapted to evaluate information about movement data of the information carrier contained in the information carrier and wherein the signal emitter is adapted to evaluate information about the movement data and, as a function of the evaluation of the movement data, to associate a reward.

41. The dispatch point recited in claim 39, wherein the reading unit is adapted to read information from an RFID tag.

42. The dispatch point recited in claim 39, wherein the information contained in the information carrier is acquired graphically.
